(19) United States
(12) Patent Application Publication
(10) Pub. No.: US 2016/0011969 A1
(43) Pub. Date: Jan. 14, 2016

(54) METHOD FOR ACCESSING DATA IN SOLID STATE DISK

(71) Applicant: QUANTA STORAGE INC., Taoyuan County (TW)

(72) Inventors: Cheng-Yi LIN, Taoyuan County (TW); Yi-Long HSIAO, Taoyuan County (TW)

(73) Assignee: QUANTA STORAGE INC., Taoyuan County (TW)

(21) Appl. No.: 14/559,471

(22) Filed: Dec. 3, 2014

(30) Foreign Application Priority Data
Jul. 8, 2014 (CN) 201410322539.9

(51) Int. Cl. G06F 12/02

(52) U.S. Cl. CPC G06F 12/0246; G06F 2212/7201

(57) ABSTRACT

A method for accessing data in solid state drive (SSD) is disclosed. The method includes: Receiving and buffering an access request; splitting the access request into a number of separate access requests each corresponding to a respective physical block; merging the separate access requests to form a reconfigured access request conformed to a flash operation mode; transmitting the reconfigured access request; accessing the reconfigured access request in a mode conformed to flash operation to increase access speed.

This application claims the benefit of People's Republic of China application Serial No. 201410322539.9, filed Jul. 8, 2014, the subject matter of which is incorporated therein by reference.

### BACKGROUND OF THE INVENTION

1. Field of the Invention

The invention relates in general to a method for accessing data in solid state drive (SSD), and more particularly to a data accessing method in which when data is accessed in SSD, the access request is split and merged to form physical units conforming to a flash operation mode in a buffer memory.

2. Description of the Related Art

Solid state drive (SSD) is composed of a plurality of non-volatile flash memories integrated into one single storage device. The SSD, having the features of lightweight, slimness, compactness, portability and fast data transmission rate, which is conducive to the transmission of a large volume of data but not requiring any rotating mechanisms, has become a mainstream data storage device in modern information products.

During data access, the SSD firstly receives a logical page address (LPA) of an access request from a host computer, converts the LPA into a physical page address (PPA) with reference to a logical-physical mapping table, and further transmits the access request to a flash memory. An ordinary flash memory has a data area and a spare area. Each area includes several physical blocks each being composed of one or more than one physical page. After the access request was received by the flash memory, the SSD reads the data of physical blocks containing the PPA from the data area and transmits the read data to the host computer to be updated. Then, the SSD selects a spare physical block from the spare area and further writes the updated data to the selected spare physical block to form a new data physical block in the data area and corrects the logical-physical mapping table accordingly. Then, the data in the old data physical block is completely erased and new spare physical block is formed in the spare area for alternate use. Thus, the physical block is a basic unit for accessing data in a flash memory. However, the method of sequentially accessing physical blocks one by one from the flash memory cannot increase the speed of data access, and is disadvantageous when it comes to the access of a large volume of data in the SSD.

Due to the advancement in the manufacturing technology of flash memory, a multi-plane flash memory is provided. The multi-plane flash memory arranges several physical blocks located on different planes but can be accessed at the same time as a physical unit which is a basic unit by which the multi-plane flash memory accesses data. The multi-plane flash memory accesses the physical blocks in the same physical unit to expedite data access. Besides, the multi-plane flash memory provides different modes of flash operation, such as single-plane operation, two-plane operation and two-plane cache operation, according to the access of physical blocks in the physical units. In the single-plane operation mode, only physical blocks conformed to the single-plane operation mode are accessed. In the two-plane operation mode, only physical blocks conformed to the two-plane operation mode are accessed. In the two-plane cache operation mode, two continuous physical units are accessed at the same time, and this is a flash operation mode supporting quick access.

As indicated in FIG. 6, a flowchart of a method for accessing data in a multi-plane flash memory by an SSD according to prior art is shown. The method begins at step R1, the SSD starts to access data. Next, the method proceeds to step R2, a data access request is received from a host computer. Then, the method proceeds to step R3, the flash operation mode in which the access request accesses physical units from the flash memory is determined according to the addresses of the sequentially accessed physical blocks of the access request. Then, the method proceeds to step R4, the access request is transmitted to relevant multi-plane flash memories. Then, the method proceeds to step R5, the physical units are quickly accessed in the flash operation mode determined in step R3. Then, the method returns to step R2, the SSD waits to receive a next access request from the host computer and continues to access data. Thus, the speed of data access can be expedited.

In the above method for accessing data in a multi-plane flash memory by an SSD, physical blocks in the same physical unit can be quickly accessed in the determined flash operation mode. However, the access request is a random access of physical blocks and has only a limited number of sequentially accessed physical blocks are conformed to the flash operation mode supporting quick access. Therefore, the flash operation mode can do very little when it comes to expedite data access. Although the accessed relevant data is particularly arranged in the physical units of the multi-plane flash memory so as to be conformed to the flash operation mode supporting quick access, after the physical blocks are randomly accessed and the physical blocks are alternately moved to the data area and the spare area of the flash memory, less and less relevant data can remain being conformed to the flash operation mode supporting quick access. Consequently, the use of the flash operation mode supporting quick access is relatively reduced, and it is very hard to expedite data access. Therefore, the SSD still has many problems to resolve when it comes to the method for accessing data in SSD.

### SUMMARY OF THE INVENTION

According to an object of the invention, a method for accessing data in SSD is disclosed. The received access request is split into a number of separate access requests each corresponding to a respective physical blocks. Then, the separate access requests are merged to form a reconfigured access request conformed to a flash operation mode supporting quick access to increase the speed for accessing data.

According to another object of the invention, a method for accessing data in SSD is disclosed. An access request is preferentially transmitted for the flash memory to operate. While waiting for operation, the separate access requests are merged to form an access request conformed to a flash operation mode supporting quick access to expedite speed of data access.

According to an alternate object of the invention, a method for accessing data in SSD is disclosed. Separate access requests each corresponding to a respective physical blocks and the reconfigured access request, which is buffered in a buffered memory and waiting to be transmitted, are merged to form a reconfigured access request conformed to a flash operation mode supporting quick access to increase the efficiency of data access.

To achieve the above objects of the invention, a method for accessing data in SSD is disclosed. An access request is received from a host computer and buffered by an SSD. The access request is split into a number of separate access requests each corresponding to a respective physical blocks according to the addresses of the physical blocks of the access request obtained with reference to logical addresses. The separate access requests are merged to form a reconfigured access request preferentially conformed to a flash operation mode supporting quick access. The reconfigured access request is transmitted to a multi-plane flash memory of the SSD. Physical units of the reconfigured access request are accessed with respect to the multi-plane flash memory in a mode conformed to flash operation.

The invention further discloses another method for accessing data in SSD. An access request is received from a host computer and buffered by an SSD. Sequenced physical blocks of the access request are preferentially transmitted to a multi-plane flash memory and in a mode conformed to flash operation. The buffered access request is split into a number of separate access requests each corresponding to a respective physical blocks while waiting for operation. Separate access requests and the buffered reconfigured access request are merged to form a reconfigured access request conformed to a flash operation mode. The reconfigured access request is transmitted to a multi-plane flash memory of the SSD after the operation is completed. Physical units of the reconfigured access request are accessed with respect to the multi-plane flash memory in a mode conformed to flash operation. When the access of the reconfigured access request is not completed, the reconfigured access request continues to be sequentially transmitted to a multi-plane flash memory of the SSD. When the access of the reconfigured access request is already completed, the SSD waits to receive the next access request.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a system structure diagram of an SSD.

FIG. 2 is a schematic diagram of data access in SSD.

FIG. 3 is a schematic diagram of an SSD accessing data according to a first embodiment of the invention.

FIG. 4 is a flowchart of a method for accessing data in SSD according to a first embodiment of the invention.

FIG. 5 is a flowchart of a method for accessing data in SSD according to a second embodiment of the invention.

FIG. 6 a flowchart of a method for accessing data in SSD according to the prior art.

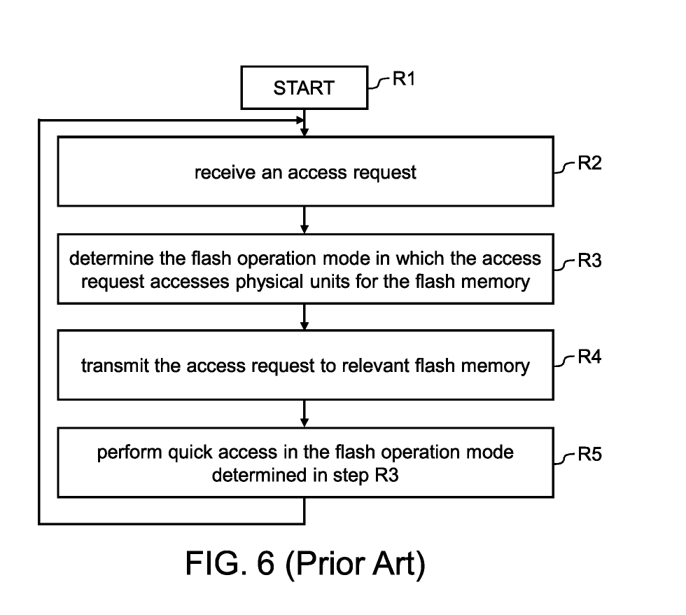

### DETAILED DESCRIPTION OF THE INVENTION

The technologies adopted to achieve the objects of the invention and the effects thereof are disclosed below in a number of exemplarily embodiments with accompanying drawings.

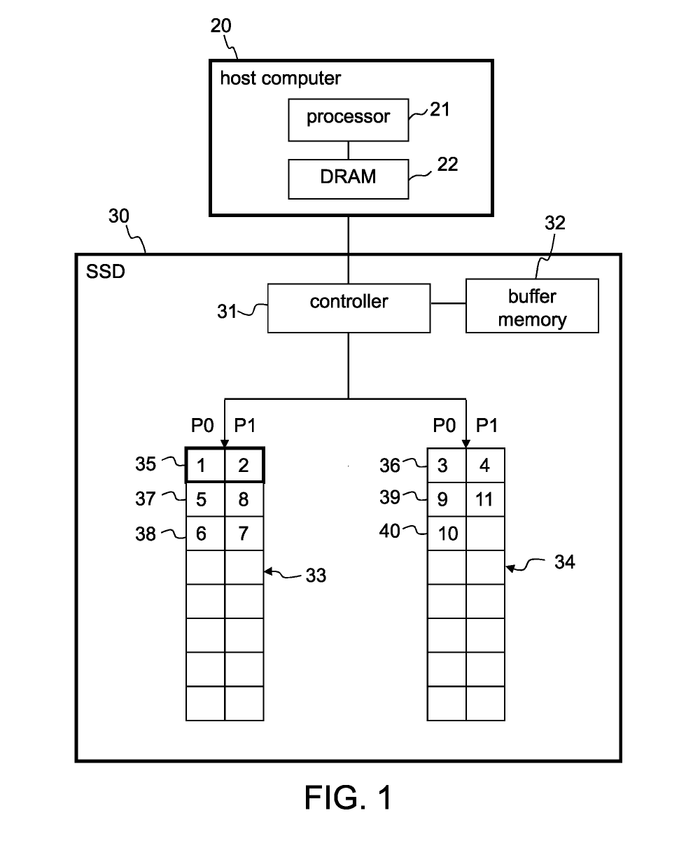

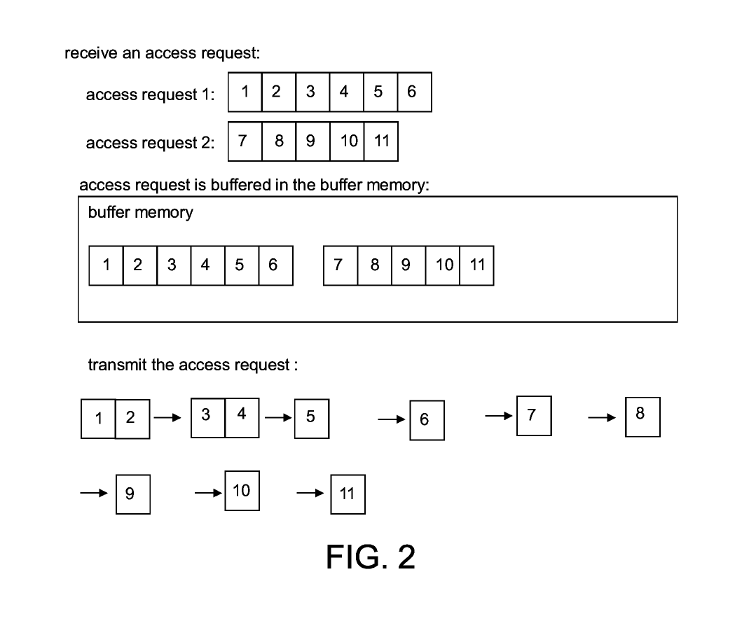

Refer to both FIG. 1 and FIG. 2. FIG. 1 is a system structure diagram of an SSD. FIG. 2 is a schematic diagram of data access in SSD. The solid state drive (SSD) system used in FIG. 1 is a generally known SSD system, which mainly includes a host computer 20 and a solid state drive (SSD) 30. The host computer 20 includes a processor 21 and a random access memory (DRAM) 22. The processor 21 transmits a data access request, and the DRAM 22 buffers the accessed data. The SSD 30 connects the host computer 20, and includes a controller 31 collaborating with a buffer memory 32 for controlling a plurality of multi-plane flash memories. In the present embodiment, two multi-plane flash memories, namely, first multi-plane flash memory 33 and second multi-plane flash memory 34, are exemplified for explanatory and exemplary purpose. Each multi-plane flash memory may include several planes. In the present embodiment, it is exemplified that each multi-plane flash memory includes two planes, that is, a 0-th plane P0 and a first plane P1. Each plane further includes a plurality of physical blocks, and two physical blocks located on different planes but can be accessed at the same time are arranged as a physical unit 35. For example, in the first multi-plane flash memory 33, physical block 1 located on the 0-th plane P0 and physical block 2 located on the first plane P1 are arranged as the same physical unit 35, and remaining physical blocks which are adjacent but located on different planes are regarded as a physical unit. Each multi-plane flash memory stores data to physical blocks such as physical blocks 1-11. Through the control of the controller 21, data stored in multi-plane flash memories can be accessed via respective channels and integrated as one single storage device used as the data storage device of the host computer 20.

The process of accessing data by the SSD 30 is described with a specific embodiment as indicated in FIG. 2. When the SSD 30 receives an access request 1 from the host computer 20, the SSD 30 accesses physical blocks 1-6 and buffers the access request to the buffer memory 32. The SSD 30 further obtains the addresses of the physical blocks of the access request with reference to the logical addresses. Based on the addresses of the physical blocks and the order of the physical block in the access request, when it is determined that physical blocks 1 and 2 of the access request 1 are located on the same physical unit 35 of the first multi-plane flash memory 33 and are conformed to a two-plane operation mode, the access request is transmitted to the first multi-plane flash memory 33, and the physical blocks 1 and 2 of the physical unit 35 are accessed at the same time by using the two-plane operation mode. When it is determined that physical blocks 3 and 4 of the access request 1 are located on the same physical unit 36 of the second multi-plane flash memory 34 and are conformed to the two-plane operation mode, the access request is transmitted to the second multi-plane flash memory 34, and the physical blocks 3 and 4 of the physical unit 36 are accessed at the same time by using the two-plane operation mode. When it is determined that physical blocks 5 and 6 of the access request 1 are respectively located on the physical units 37 and 38 instead of the same physical unit, the physical blocks 5 and 6 are only conformed to a single-plane operation mode, the access request is sequentially transmitted to the first multi-plane flash memory 33, and the physical blocks 5 and 6 are sequentially accessed from the physical units 37 and 38 respectively.

During the process of processing the access request 1, the SSD 30 may further receive an access request 2 from the host computer 20. If so, the SSD 30 sequentially accesses and buffers physical blocks 7-11 to the buffer memory 32, and obtains the addresses of the physical blocks of the access request with reference to the logical addresses. Likewise, after the processing of the access request 1 is completed, when it is determined that physical blocks 7 and 8 of the access request 2 are both conformed to the single-plane operation mode, the access request is sequentially transmitted to the first multi-plane flash memory 33, and are given to sequentially access the physical blocks 7 and 8 from the physical units 37 and 38 respectively. When it is determined that physical blocks 9-11 of the access request 2 are only conformed to a single-plane operation mode, the access request is sequentially transmitted to the second multi-plane flash memory 34, and the physical blocks 9-11 are sequentially accessed from the physical units 39-40 respectively. Therefore, it takes the generally known SSD 30 after nine operation of data access to complete the access of the physical blocks 1-11 of the access request 1-2.

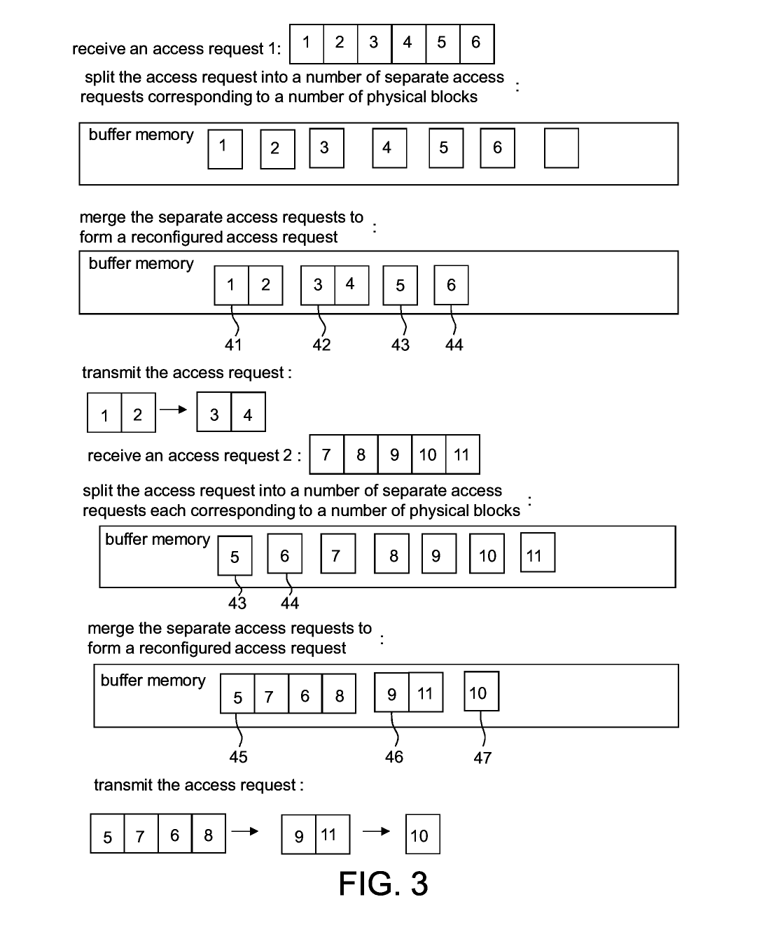

Refer to both FIG. 1 and FIG. 3. FIG. 3 is a schematic diagram of an SSD accessing data according to a first embodiment of the invention. To increase access efficiency, when the SSD 30 of the first embodiment of the invention accesses data, the SSD 30 receives an access request from the host computer 20, buffers the access request to the buffer memory 32, and obtains the addresses of the physical blocks of the access request with reference to the logical addresses, and splits the access request split into a separate access request corresponding to a respective physical blocks. Based on the addresses of the physical blocks, the separate access requests are merged to form a reconfigured access request preferentially conformed to a flash operation mode supporting quick access. Then, the reconfigured access request is sequentially transmitted to each multi-plane flash memory from the buffer memory 32, and the reconfigured access request is accessed with respect to physical units. During the accessing process, if the SSD 30 consecutively receives a new access request from the host computer 20, likewise, the newly received access request is buffered to the buffer memory 32, the addresses of the physical blocks of the newly received access request are obtained with reference to the logical addresses of the newly received access request, and the newly received access request is split into a number of separate access requests. The separate access requests and the reconfigured access request, which is buffered in the buffer memory 32 and waiting to be transmitted, are merged to form a reconfigured access request conformed to a flash operation mode.

The process of accessing data by an SSD is described with a specific embodiment as indicated in FIG. 3. Firstly, the SSD 30 of the first embodiment of the invention receives an access request 1 from the host computer 20, accesses data of physical block 1-6, and buffers the access request 1 to the buffer memory 32. The SSD 30 further obtains the addresses of the physical blocks 1-6 of the access request with reference to the logical addresses, and further splits the access request 1 split into a number of separate access requests corresponding to a number of physical blocks 1-6. Preferentially, the flash operation mode supporting quick access is used. Based on the addresses of the physical blocks 1-6, when it is determined that physical blocks 1 and 2 of the access request 1 are located on the same physical unit 35 of the first multi-plane flash memory 33, the physical blocks 1 and 2 are merged to form a reconfigured access request 41 conformed to a two-plane operation mode. When it is determined that physical blocks 3 and 4 of the access request 1 are located on the same physical unit 36 of the second multi-plane flash memory 34, the physical blocks 3 and 4 are merged to form a reconfigured access request 42 conformed to the two-plane operation mode. When it is determined that physical blocks 5 and 6 of the access request 1 are respectively located on physical units 37 and 38 of the first multi-plane flash memory 33 instead of being located on the same physical unit, the physical blocks 5 and 6, which are only conformed to a single-plane operation mode, cannot be merged to form a reconfigured access request and will form two reconfigured access requests 43 and 44 instead. Then, the reconfigured access request 41 is sequentially transmitted to the first multi-plane flash memory 33, and the physical blocks 1 and 2 are accessed at the same time. Then, the reconfigured access request 42 is sequentially transmitted to the second multi-plane flash memory 34, and the physical blocks 3 and 4 are accessed. Meanwhile, since the access channels are full, the reconfigured access requests 43 and 44 are buffered to the buffer memory 32, and will not be accessed until the access channel becomes available after the access of the multi-plane flash memory is completed (time out).

During the process of accessing data from the multi-plane flash memory, the SSD 30 consecutively receives an access request 2 from the host computer 20, accesses data of physical blocks 7-11 and buffers the access request 2 to the buffer memory 32 together with the reconfigured access requests 43 and 44 which are buffered in the buffer memory 32 and waiting to be transmitted. The SS 30 further obtains the addresses of the physical blocks 7-11 of the access request 2 with reference to the logical addresses, and splits the access request 2 split into a number of separate access requests corresponding to a number of physical blocks 7-11. Preferentially, the flash operation mode supporting quick access is used. Based on the reconfigured access requests 43 and 44 and the addresses of the physical blocks 7-11, when it is determined that the physical block 7 of the access request 2 and the physical block 5 of the reconfigured access request 43 are located on the same physical unit 37 of the first multi-plane flash memory 33, that the physical block 8 of the access request 2 and the physical block 6 of the reconfigured access request 44 are located on the same physical unit 38 of the first multi-plane flash memory 33, and that the physical units 37 and 38 are arranged in a top-down manner and adjacent to each other, the physical blocks 5-8 can be merged to form a reconfigured access request 45 conformed to a two-plane cache operation mode. Then, when it is determined that physical blocks 9 and 11 of the access request 2 are located on the same physical unit 39 of the second multi-plane flash memory 34, the physical blocks 9 and 11 can be merged to form a reconfigured access request 46 conformed to a two-plane operation mode. When it is determined that physical block 10 of the access request 2 cannot be merged with any other physical blocks of the buffered access requests, the physical block 10 is only conformed to a single-plane operation mode and forms a reconfigured access request 47. When the multi-plane flash memory has an available access channel, the reconfigured access requests are sequentially transmitted to the multi-plane flash memory. In comparison to the generally known method for accessing data in SSD which requires 11 times of the operation of data access, the method for accessing data in SSD according to the first embodiment of the invention only requires 5 times of the operation of data access to complete the processing of the access requests 1-2, and has a faster access speed.

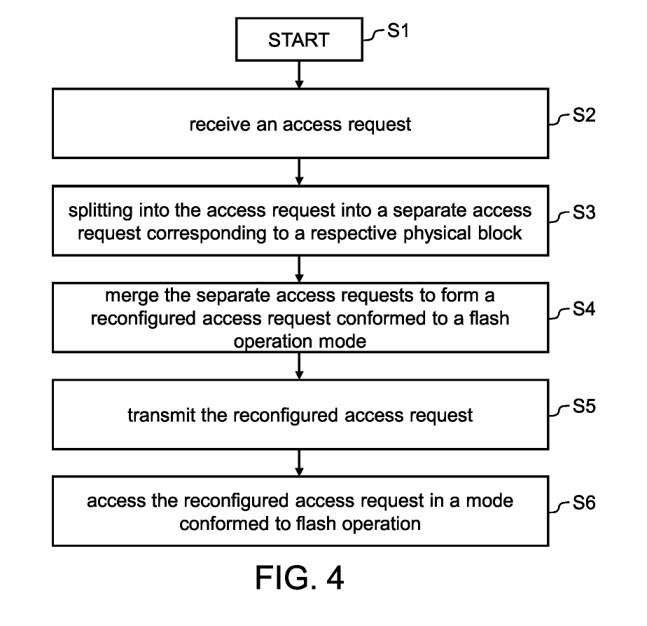

Refer to FIG. 4, a flowchart of a method for accessing data in SSD according to a first embodiment of the invention is shown. Detailed steps of the method for accessing data in SSD according to the first embodiment of the invention are disclosed below. Firstly, the method begins at step S1, the SSD of the first embodiment of the invention starts to access data. Next, the method proceeds to step S2, an access request is received from a host computer and buffered to a buffer memory by the SSD. Then, the method proceeds to step S3, the addresses of the physical blocks of the access request are obtained with reference to the logical addresses, and the access request is split into a number of separate access requests corresponding to a number of physical blocks. Then, the method proceeds to step S4, based on the addresses of the physical blocks, separate access requests are merged to form a reconfigured access request conformed to a flash operation mode supporting quick access. Then, the method proceeds to step S5, the reconfigured access request is transmitted to each multi-plane flash memory from the buffer memory. Then, the method proceeds to step S6, physical units of the reconfigured access request are accessed in a mode conformed to flash operation.

Therefore, based on the data accessing process of the method for accessing data in SSD of the first embodiment of the invention, the received access request is split into a number of separate access requests corresponding to a number of physical blocks, then the separate access requests are merged to form a reconfigured access request conformed to a flash operation mode supporting quick access and sequentially transmitted to each multi-plane flash memory, and physical units of the reconfigured access request are accessed in a mode conformed to flash operation.

To access data with the SSD of the first embodiment of the invention data access, processing time is required for the SSD to split the received access request split into a number of separate access requests and merge the separate access requests to form a reconfigured access request, before the SSD can transmit the reconfigured access request to each multi-plane flash memory. Each multi-plane flash memory will be in a waiting state until the reconfigured access request is received. Thus, in order to increase the access speed, during the accessing process of the method for accessing data in SSD according to a second embodiment of the invention, each multi-plane flash memory preferentially performs data accessing once an access request is received from the host computer by the SSD. While waiting for the multi-plane flash memory to make the access channel available, the access request is split in the buffer memory and merged with the reconfigured access request buffered in the buffer memory to form a new reconfigured access request, so as to increase the access speed of the SSD of the first embodiment of the invention.

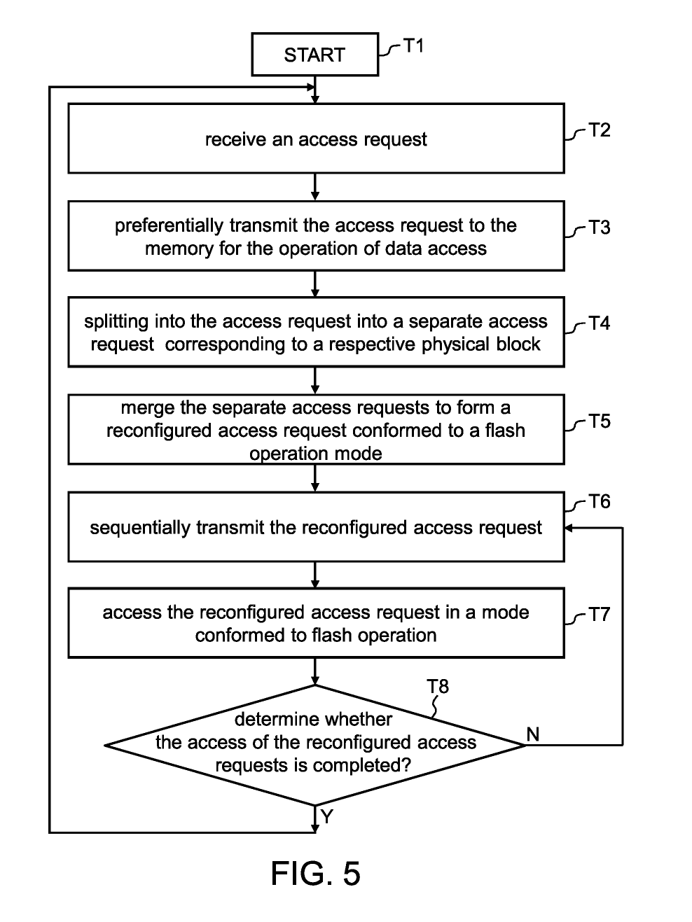

Refer to FIG. 5, a flowchart of a method for accessing data in SSD according to a second embodiment of the invention is shown. Detailed steps of the method for accessing data in SSD according to the second embodiment of the invention are disclosed below. Firstly, the method begins at step T1, the SSD of the first embodiment of the invention starts to access data. Next, the method proceeds to step T2, an access request is received from a host computer and buffered to a buffer memory by the SSD. Then, the method proceeds to step T3, conformable flash operation mode is determined according to the addresses of the sequenced physical blocks of the access request, and the access request preferentially is transmitted to the multi-plane flash memory for the operation of data access. Then, the method proceeds to step T4, while waiting for operation, the buffered access request is split into a number of separate access requests corresponding to a number of physical blocks. Then, the method proceeds to step T5, the separate access requests and the reconfigured access request buffered in the buffer memory are merged according to the addresses of the physical blocks to form a reconfigured access request conformed to a flash operation mode supporting quick access. Then, the method proceeds to step T6, after the operation is completed, the reconfigured access request is sequentially transmitted to each multi-plane flash memory from the buffer memory. Then, the method proceeds to step T7, physical units of the reconfigured access request are accessed in a mode conformed to flash operation. Then, the method proceeds to step T8, whether the access of the reconfigured access requests in the buffer memory is completed is determined. If the access of the reconfigured access requests is not yet completed, the method returns to step T6, the reconfigured access request is sequentially transmitted. If the access of the reconfigured access requests is completed, the method returns to step T2 to wait for receiving the next access request.

Therefore, based on the above data accessing process, the invention the second embodiment method for accessing data in SSD, the access request is preferentially transmitted for the flash memory to operate, and while waiting for operation, the access request is split into a number of separate access requests corresponding to a number of physical blocks. Then, the separate access requests and the reconfigured access requests, which are buffered and waiting to be transmitted, are merged to form a reconfigured access request conformed to a flash operation mode supporting quick access to increase the data access efficiency of the SSD.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for accessing data in solid state drive (SSD), comprising:
receiving and buffering an access request from a host by an SSD;
splitting the access request into a separate access request corresponding to a respective physical block;
remerging the separate access request to form a reconfigured access request conformed to a flash operation mode;
transmitting the reconfigured access request to a multi-plane flash memory of the SSD;
accessing physical units of the reconfigured access request from the multi-plane flash memory in a mode conformed to flash operation.

2. The method for accessing data in SSD according to claim 1, wherein the received access request is buffered to a buffer memory.

3. The method for accessing data in SSD according to claim 1, wherein the access request is split according to an address of the physical block of the access request obtained with reference to a logical address.

4. The method for accessing data in SSD according to claim 3, wherein the separate access request is merged according to the address of the physical block and preferentially in a mode conformed to a flash operation supporting quick access.

5. A method for accessing data in SSD, comprising:
receiving and buffering an access request from a host by an SSD;
preferentially transmitting the sequenced physical block of the access request to a multi-plane flash memory and accessing the transmitted access request in a mode conformed to flash operation;
splitting the buffered access request into a separate access request corresponding to a respective physical block while waiting for operation;
remerging the separate access request to form a reconfigured access request conformed to a flash operation mode;
transmitting the reconfigured access request to a multi-plane flash memory of the SSD after the operation is completed;
accessing the reconfigured access request for a physical unit of the multi-plane flash memory in a mode conformed to flash operation.

6. The method for accessing data in SSD according to claim 5, wherein conformable flash operation mode is determined according to an address of the sequenced physical block of the access request.

7. The method for accessing data in SSD according to claim 5, wherein the separate access request is merged according to an address of the physical block and preferentially in a mode conformed to a flash operation supporting quick access.

8. The method for accessing data in SSD according to claim 7, wherein during the process of merging, the split separate access request and the buffered reconfigured access request are merged.

9. The method for accessing data in SSD according to claim 5, wherein when the reconfigured access request which is not yet completed is determined, the reconfigured access request continues to be sequentially transmitted to a multi-plane flash memory of the SSD.

10. The method for accessing data in SSD according to claim 9, wherein when the reconfigured access request which is already completed is determined, the SSD waits to receive the next access request.
